(19) United States
(12) Patent Application Publication
(10) Pub. No.: US 2022/0302711 A1
(43) Pub. Date: Sep. 22, 2022

(54) MODULAR CLEAN ENERGY SYSTEMS AND METHODS

(71) Applicant: Horsepower Energy LLC, Dallas, TX (US)

(72) Inventors: Nathan Schell, Dallas, TX (US); Ryan Hamar, Wylie, TX (US); Daniel Jason Grounds, Plano, TX (US); Shawn Clark, Edmond, OK (US); David Jones, Tyler, TX (US); Aaron Prince, Colorado Springs, CO (US); Daniel McGuire, Dallas, TX (US)

(21) Appl. No.: 17/700,389

(22) Filed: Mar. 21, 2022

Related U.S. Application Data
(60) Provisional application No. 63/163,667, filed on Mar. 19, 2021.

(51) Int. Cl. H02J 3/38; H02J 3/46

(52) U.S. Cl. CPC H02J 3/381; H02J 3/46; H02J 2300/22; H02J 2300/28; H02J 2300/10

(57) ABSTRACT

A versatile, modular power system is described which includes a refinery in conjunction with renewable energy sources and a vapor recovery unit which in combination with power from sources of renewable energy produces stacked power to be stored in a power storage center, to be used back in the system or to be distributed to an external power grid.

This patent application claims priority to U.S. Provisional Patent Application Ser. No. 63/163,667, filed Mar. 19, 2021, the content of which is hereby incorporated by reference herein in its entirety into this disclosure.

### BACKGROUND OF THE SUBJECT DISCLOSURE

### Field of the Subject Disclosure

The present subject disclosure relates to modular clean energy systems and methods. More specifically, the present subject disclosure relates to clean energy systems and methods which combine conventional and clean energy sources while minimizing the carbon footprint.

### Background of the Subject Disclosure

Harnessing power is one of the greatest feats of human ingenuity. To be able to capture, store, and release power at will has allowed an endless advancement of human progress. Further, virtually everything humans use need some sort of power source, whether it is through natural resources (coal, sun, wind, water), or human created (nuclear, etc.). Conventionally, power is provided to consumer through a variety of original sources, including solar, wind, geothermal, fossil fuel, etc. The level of environmental impact of harnessing and storing of such power varies depending on the source.

The need to provide different modes of manufacture to capture, harness, create, support, repair, replace, regenerate, and recycle different sources of power leads to inefficiencies in the system, higher costs to consumers, and more detrimental long term environmental impact.

### SUMMARY OF THE SUBJECT DISCLOSURE

The present subject disclosure describes clean energy systems and methods which are designed to be modular, hybrid, resilient, versatile, and relatively inexpensive to set up, repair, operate, and dismantle. The clean energy systems and methods according to the present subject disclosure allow for the efficient combination and/or interaction of various sources of energy, using a novel and efficient circular energy loop, by making use and incorporating clean energy sources. The setup and use of the modular clean energy systems and methods according to the present subject disclosure may be completed within days to weeks, rather than months to years, as in standard energy systems. Similarly, the dismantling of the systems and methods are equally efficient, and designed to leave little to no carbon footprint.

In one exemplary embodiment, the present subject disclosure is a power system. The power system includes a refinery adapted to have an intake of crude oil and produce an output of refined products and vapors; a micro turbine that produces power from the vapors from the refinery; one or more sources of renewable energy which produce green power; and a power storage center which stores total power formed by the power from the micro turbine and the green power.

In another exemplary embodiment, the present subject disclosure is a power system. The power system includes a refinery adapted to have an intake of crude oil and an output of refined products and fuel gas; a vapor recovery unit which collects the fuel gas output from the refinery; a micro turbine that produces power from the fuel gas collected by the vapor recovery unit; one or more sources of green power; a power storage center which stores total power formed by the micro turbine and the green power; and a grid which distributes the total power stored in the power storage center.

In yet another exemplary embodiment, the present subject disclosure is a power system. The power system includes a refinery adapted to have an intake of crude oil and produce an output of refined products and vapors; a modular vapor recovery unit positioned on a skid which collects the vapors produced in the refinery; a modular micro turbine positioned on a skid that produces power from the vapors collected by the vapor recovery unit; one or more sources of renewable energy which produce green power; a modular power storage center positioned on a skid which stores a combination of power formed by the micro turbine and the green power; and a modular grid positioned on a skid which distributes the combination power stored in the power storage center.

### BRIEF DESCRIPTION OF THE DRAWINGS

FIG. 1 shows a schematic perspective of a modular clean energy system, according to an exemplary embodiment of the present subject disclosure.

FIG. 2 shows a top view of a modular clean energy campus, according to an exemplary embodiment of the present subject disclosure.

FIG. 3 shows a flow diagram of an operation of a modular clean energy system, according to an exemplary embodiment of the present subject disclosure.

FIG. 4 shows a schematic perspective of refinery process and equipment, according to an exemplary embodiment of the present subject disclosure.

FIG. 5 shows a schematic perspective of a distillation process and associated equipment incorporating the refinery process and equipment shown in FIG. 4, according to an exemplary embodiment of the present subject disclosure.

FIG. 6 shows a side perspective view of a single pod power source generating different magnitudes of power incorporated in a utility scale energy storage system (ESS), according to an exemplary embodiment of the present subject disclosure.

### DETAILED DESCRIPTION OF THE SUBJECT DISCLOSURE

The present subject disclosure addresses, among other things, the inefficient problem of combining two or more sources of power, refining, and storing them, and readying them for use as needed, while minimizing the environmental impact of having to process each source of energy separately.

As described herein and throughout this disclosure, systems and methods according to the present subject disclosure will be presented as a “campus” which entails a combination of various energy sources which are inter-connected and combined in a novel manner to emphasize efficiency and preservation of energy while minimizing any carbon footprint.

Each campus is custom built according to a specific client's needs and the energy resources available on location. For example, a campus built in the Brazil Amazon basin may be designed differently than a campus built in the deserts of Kuwait. At the core of the campus is a “clean” petroleum refined product production facility utilizing skid based modular refining equipment and power storage with a micro grid control system. The campus, and therefore systems and methods, according to the present subject disclosure, are intended to be energy efficient, net-zero (carbon neutral), sustainable, and autonomous. The campus creates a stacked energy center, combining various sources of energy together to create bulk energy storage, which is partially used to run itself, get stored for future use, and gets distributed out to the grid, as needed. Renewable or “green” energy production and utilization is the preferred method of energy creation although any method could be utilized and incorporated into the campus. As global energy demand increases, the uniqueness, flexibility, stackable, and modular nature of the green looped energy campus system is positioned to responsibly meet those needs with a flexible and focused multi-source program.

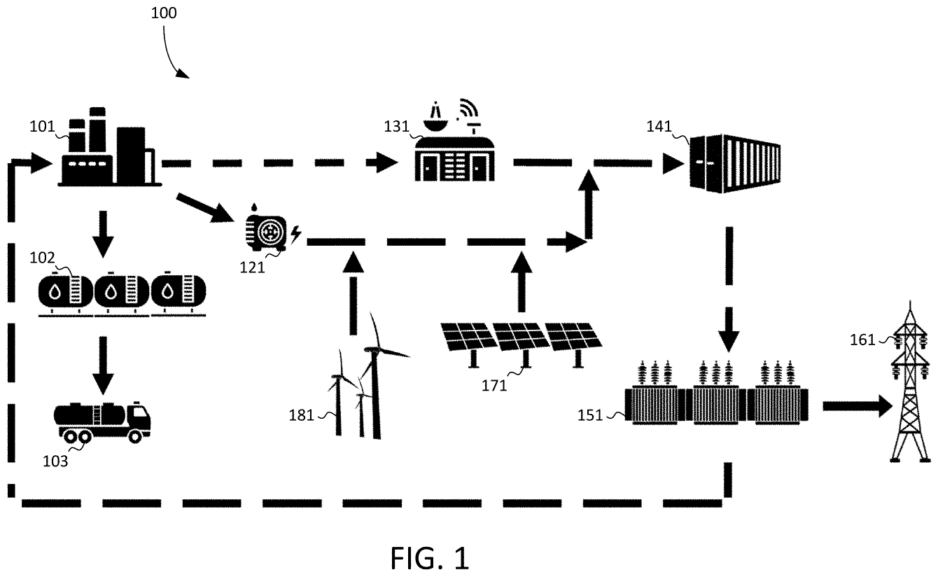

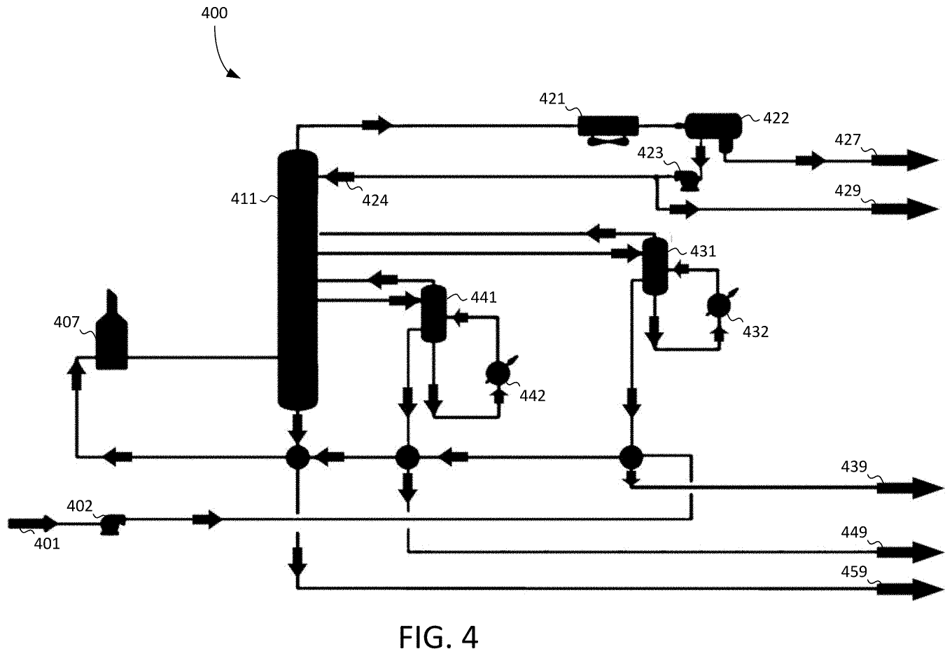

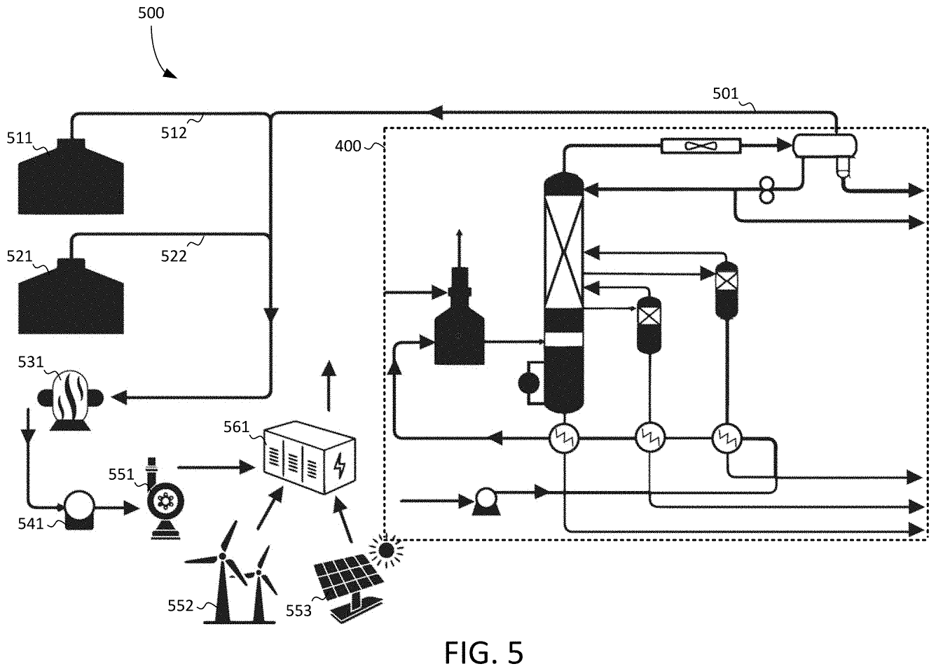

An exemplary campus 100 according to the present subject disclosure, is shown in FIG. 1. A refinery 101 receives fuel which is stored in refinery storage 102, and ultimately transported through tanker trucks 103, tanker ships, oil pipes, etc., to its destination. It should be noted that the refinery 101 can be on site at a location where oil is drawn out, or it can be at a remote location where oil is shipped, trucked, piped, or otherwise delivered thereto. Details of the refinery 101 will be shown and discussed in FIGS. 4-5.

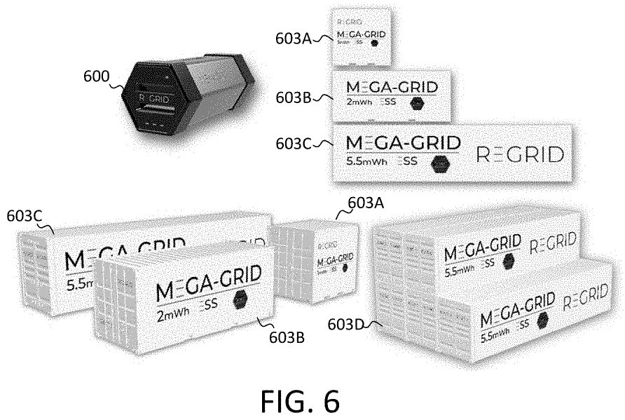

A micro turbine generator 121 receives vapors from the refinery 101 and with the use of add on green technology from one or more sources, produces energy stores 141. The green technology may include, for example solar power from solar panels 171, and wind power from wind turbines 181. Other green energy sources may be added to the flow, but are not shown in the figure for sake of simplicity. The stored power 141 may be in various forms, such as, but not limited to, battery, capacitors, and inverters. One such non-limiting example of a battery storage would be a lithium-iron phosphate battery. Other types of power storage are also possible and within the scope of the present disclosure. One non-limiting type of power storage is shown and described in FIG. 6. The power storage 141 may then be used as needed through microgrid controllers and transformers 151, and fed back into the refinery 101 as needed, to create a green energy loop, as shown in FIG. 1. Additionally, the stored power 141 may also be transferred and/or sold to needs outside of the campus 100 through connection to the electric grid 161. A control center 131 monitors the data and regulates all portions of the campus 100 through interaction with all components.

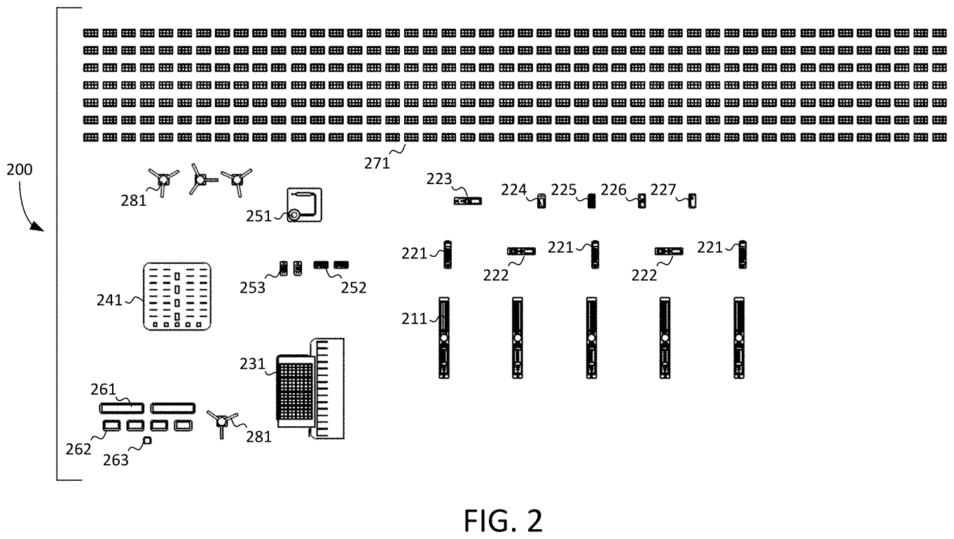

FIG. 2 shows an exemplary embodiment of a clean energy campus 200, according to the present subject disclosure, which combines multiple energy technologies stacked in a single area. In this campus 200, the system combines skid based modular refining equipment 221, 222, 223, 224, 225, 226, 227 with multi-MW electrical battery storage systems 261, 262, 263, and clean or green stacked energy production such as, but not limited to: micro turbine generators 253, solar panel farm 271, windmills 281, hydro, geothermal, fuel cells, or other energy production methods (not shown), and then ties all of these items together with an electrical microgrid. The connections between the components shown for the clean energy loop campus 200 shown in FIG. 2 are not shown for sake of simplicity. However, such connections are shown in detail in FIGS. 1 and 3-5.

The general design of the clean energy campus 100 incorporates small modular refineries 211 with a scalable daily throughput of around 2,000 to 30,000 barrels per day (bpd) each that can be built in multiples for increased volumes. One particular example provides a daily throughput of around 10,000 barrels per day. Five refineries 211 are shown in the example of FIG. 2, but any number is possible. This configuration cuts down on manufacturing and construction costs and shortens the construction schedule. The campus 200 is designed such that it captures the fugitive emissions and light gases to feed a micro turbine 253 for energy production and emissions reductions. The details of the capture and routing of the gas vapors from the refinery will be presented in more detail in FIGS. 4-5. Additional energy is generated in the green loop campus 200 with a solar panel array or farm 271, a windmill array 281, and/or other energy production sources listed above (not shown in the figures for sake of simplicity). All of this is connected together with a large power storage module 261, inverter and transformer 262, and microgrid 263 facility. The large power storage module may be any desired capacity, for example, 1-4 megawatt per unit.

In the specific example shown in FIG. 2, a series of 10,000 bpd refineries 211 (five shown as an example) feed into a series of refining equipment skids used in the crude separation process. The crude refining equipment skids include, for example, hydrotreater skid 221, hydro generator 222, de-sulphur skid 223, naphtha catalytic reformer skid 224, gasoline blending skid 225, jet fuel polishing and blending skid 226, and amine gas skid 227. The 221, 222, 223, 224, 225, 226, 227 skid series are examples of different refinery fuel treatments depending on a specific location or need. Further detail and use of the skids are shown in FIGS. 4 and 5.

A control room or office 231 monitors all the processes in the campus 200. An electrical substation 241, such as 12 mW, controls flow of power. A microgenerator layout includes a flare/combustor 251, vapor recovery unit (VRU) 252, and micro turbine generator skid 253. An energy storage system (ESS) and electrical stores includes a power storage 261, which may be, for example, 5.5 mWh. An inverter & transformer 262, and microgrid controller 263 complete the ESS system.

A number of renewable power sources, as listed elsewhere, may be connected into the system 200. For sake of simplicity, two such examples are shown in this campus 200. A solar array 271 includes a series of solar cells tied together to generate power from light. One or more wind turbines 281 are also tied into the campus 200 to generate power from wind power.

The result is “cleaner” refined fuels, (Naphtha, Gasoline, Kerosene, Jet fuel, Diesel, Fuel Oils, Asphalt), and “green” electricity that can be stored and used on the peak needs periods for maximum value.

This campus 200 configuration can also create a stand-alone facility that requires no outside energy sources. For example, the campus system is highly scalable for size and geographic location. The campus 200 may be implemented on a large desert field in an oil rich location, or can be implemented with minimal equipment on a rooftop of a building to provide renewable power to the building. The campus 200 may be implemented in movable targets such as ocean-going vessels, including but not limited to cruise ships, converted cargo ships, oil tankers, aircraft carriers, etc. The campus 200 may also be implemented on land vehicles, including but not limited to large truck-based configurations. One non-limiting example would be semi-trucks with each part of the campus 200 set up and pulled in a trailer, to be able to set up a quick campus in the field. Further, the campus 200 may be set up on a remote location such as the surface of celestial bodies, including the moon or other planets. The modular, scalable, and self-sufficient green circular power nature of the campus 200 is such that it may be designed and scaled to generate renewable power at any location on earth, moon, planets, or celestial bodies.

Process Overview

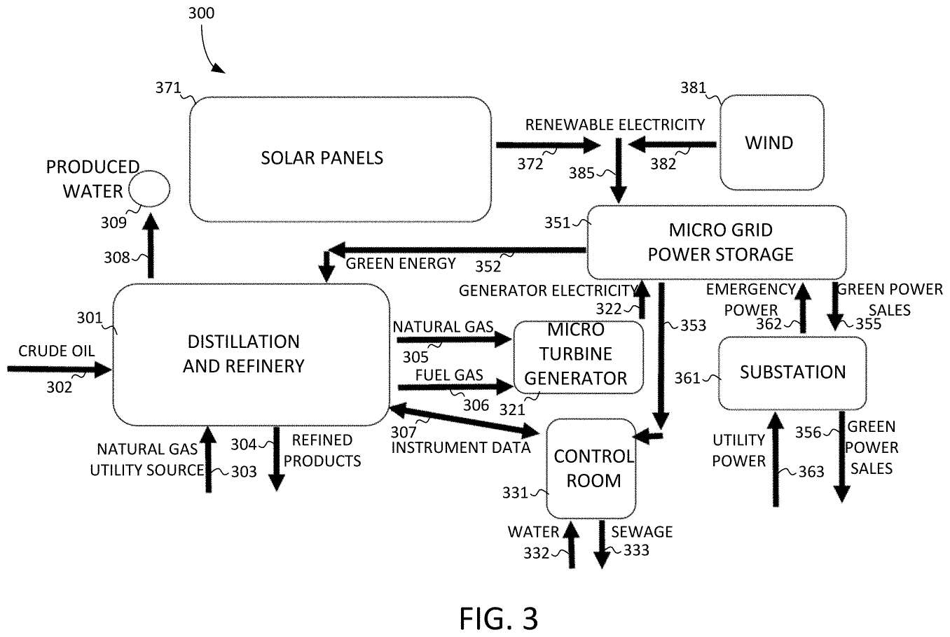

FIG. 3 show an exemplary embodiment of a process flow diagram (PFD) associated with an exemplary green loop energy campus, as shown in FIGS. 1, 2, and 5. The overall function of the PFD 300 of the clean energy campus centers around a distillation and refinery 301 which uses a natural resource, such as crude oil 302 as feedstock, and produces refined products 304 and fuel gas 306. Any water 309 produced at the refinery 301 is also directed out 308 of the refinery 301. Natural gas 305 and fuel gas 306 may be used to power a micro turbine generator 321, which generates electricity 322 to be stored in a power storage center 351, which may be bases on a battery, capacitor, inverter, etc. Other natural energy sources (e.g., solar 371, wind 381, etc.) may also add green based power to the power storage center 351. For example, solar panels 371 produce power 372 and wind 381 produces power 382, which combined create renewable electricity 385 to the micro grid power storage 351.

The power stored in the power storage center 351 can be cycled back 352 to power the refinery 301, and also used to power 353 a control center or room 331, which controls the various components of the campus 300. The control center or room 331 has a water intake 332 and a sewage outflow 333. The control center or room 331 interacts with various components of the campus 300, and determines instrument data and control flow with the refinery 301.

The power in the power storage center 351 may be sold or exported to an electrical grid through routes 355, 356 through substation 361. If need be, substation 361 can receive utility power 363 from the grid, and kick back emergency power to the power storage center 351, as needed. In essence, this campus 300 is designed to be completely self-sufficient through a green energy loop and not only require no external electrical power to operate, but used to provide power to the electrical grid, or sell power directly to consumers or a work facility. If power outages to the electrical grid occur, a plurality of such campuses 300 can be activated to provide direct power to the electrical grid to quickly generate power again.

A more detailed description of the various components of the campus will be described in detail below.

Refinery Equipment

As shown in the schematic of the refinery and distillation processes of FIGS. 4-5, the refinery and refinery equipment 400 uses petroleum crude oil 401 as a feedstock to produce refined fuels and other petroleum products. The refinery 400 is composed of a crude topping distillation skid unit and finished product refining modules. Crude oil 401 is pumped in 402 and heated through heater 407 to the crude distillation tower unit 411. The distillation unit 411 separates the crude oil 401 into light fuel gasses 429, naphthalene 422, kerosene 439, diesel 449, and residual oils and tars 459. A naphtha condenser 421 and naphtha accumulator 422 produce water 427 and straight line gasoline 429 which is pumped 423, with reflux 424 going back to the distillation tower 411. A kerosene stripper 431 and reboiler 432 produce kerosene 439. A diesel stripper 441 and reboiler 442 produce diesel 449. These raw products are then converted into usable finished products using specific refining skid-based equipment. The finished product output of the combined facility is gasoline, jet fuel, kerosene, diesel, other fuels and chemicals, and petroleum tars.

Distillation Equipment Description

The exemplary campus according to the present subject disclosure includes the design, engineering, procurement, fabrication, erection and operation at site of multiple 10,000 BPD modularized Crude Topping Units 411 and associated product Finishing Facilities. Any manufacturer may be used to supply refinery systems, including but limited to, for example, RETX. The Crude Topping units (Distillation units) 411 are capable of producing light fuel gas, Un-stabilized Naphtha, Kerosene, Diesel and Residuum. Each Crude Topping Unit 411 includes process modules containing pumps, heat exchangers, air exchangers/coolers, Automated Control System, Fractionation Column, pipe racks and Charge Heater. The finishing modules include the needed equipment to take the raw feeds from the Distillation Topping unit 411 and make them into salable spec gasoline, Jet A fuel, ULS Diesel, and asphalt.

Each green energy campus according to the present subject disclosure is customized to respond to the client or regional demand for refined products and requested salable products. Typical product spread is Naphtha, Gasoline, Kerosene, Jet fuel, Diesel, Fuel Oils, and Asphalt.

Equipment and systems are assigned to modules in a manner consistent with good engineering practices, design, safety and maintenance philosophy. The approximate dimensions of each of the modules are limited to, for example, 15.2 m (50 ft) long, by 4.3 m (14 ft) wide by 3.6 m (12 ft) high. The Crude Distillation Topping Unit, Finishing Unit Facilities, VRU/Combustor system and associated Electrical equipment, as described in this disclosure, are designed and fabricated specifically for portability and installation at various chosen sites. The use of modular construction techniques and design maximizes shop build quality controls and minimizes field installation efforts, schedule, and control. All materials required for the field installation are procured and shipped with the modular units.

Each of the distillation units 400 may include one or more of the following pieces of equipment: Crude Oil Heater, Atmospheric Distillation Column, Naphtha Overhead Accumulator, Gas/Water Separator, Kerosene Side Stripper, Diesel Side Stripper, Heat Exchangers, Pumps & Motors.

Refinery Equipment Description

Additional equipment is needed for the refining of the distillates to the desired salable products. Each of the refining equipment packages are also skid mounted for easy transportation, installation, and standardization. Each of these refining skids are built for a certain capacity that is sized for individual distillation trains or the full capacity of the multiple distillation unit facility. There is a need for multiple skids of certain types of refined products conditioning equipment to meet the overall plant capacity.

The final products refining equipment may include, but are not limited to: Naphtha Catalytic Reformer Skid, Gasoline Blending Skid, Jet Fuel Polishing & Blending Skid, Amine Skid, Hydrogen Generator, Hydrotreater Skid/De-Sulphur Skid, Pumps & Motors.

Distillation Process Flow

As shown in FIG. 5, the exemplary campus 500 is designed for clean operation and efficient energy utilization. The refinery equipment 400 (as shown and described in detail in FIG. 4) is attached to a vapor recovery unit (VRU) 531, micro turbine generator 551, and a low NOx combustor (not shown). This combination of equipment ensures safe and efficient utilization of the fuel gas and fugitive fumes with the lowest impact to environment.

To accomplish this green energy loop, each process or storage unit 511, 521 is connected to a vapor recovery unit (VRU) 531 and the hydrocarbon gasses 501, 512, 522 are utilized to produce electricity. The gasses are collected, turned into compressed fuel 541, and then routed to the micro turbine generator 551 where they are burned in a Low NOx burner/combustor (not shown) to generate electricity. If the micro turbine 551 is not available or there is too much refinery fuel gas, then the excess is disposed of in the low NOx combustor as a waste process.

VRU

The refinery facility fume and vapor control is accomplished with a VRU 531 that collects the gasses from the recycle storage tank, the Naphtha three phase separator, and any other fume source. A standard VRU skid package is shown in FIG. 5. In the figure, hydrocarbon vapor recovery 511 from the naphtha accumulator 422 (see FIG. 4), along with hydrocarbon vapor recovery 512 from crude storage tanks 511, and hydrocarbon vapor recovery 522 from fuel storage tanks 512 are fed into the VRU 531. A VRU 531 is an engineered compression package, which creates compressed fuel 541, and aims to lower emissions levels coming from the vapors of fuels while recovering valuable hydrocarbons to be reused as fuel onsite. A package for vapor recovery is designed to capture more than 95% of BTU-rich vapors, generating many benefits, guaranteeing less air pollution, and recovering vapors to be used as fuel. A list of benefits of VRUs include, but are not limited to: reduces air pollution emissions from the facility; helps meet air permit limits; reduces risk of liability associated with greenhouse gas emissions; can be installed in hazardous areas; requires no flame; easy to operate and maintain; and operates 24/7/365.

Micro Turbine Generator

The campus 500 incorporates micro turbine generators 551 to both cleanly utilize and burn the fuel gas generated from the distillation process and to generate clean electricity for the reuse in the refinery facility. A standard micro turbine generator package is shown within FIG. 5. Micro turbine generators 531 are very clean burning low NOx high heat systems that have high reliability and service life. The size and quantity of micro turbines 561 incorporated into the campus design is driven by the amount of process fuel gas generated and any other electricity makeup needs. Additional electrical power can be produced by supplementing fuel source with natural gas from local pipeline supply.

Combustor

The combustor is an emergency piece of equipment that is only used when the refinery plant discharge rate of gases is more than the micro turbine generators 551 can process. The Combustor system consists of a stack, burner, liquid knock-out drum, operating liquid pumps, instrumentation and pilot gas ignition and flame detection system rated for emergency relief of the refinery facilities.

Renewable Energy Farm

The clean energy campus 500 is a stacked “clean” energy producer. In stacked clean energy farms “green” renewable resource power generation is incorporated into the overall energy suite to create a carbon balanced or close to neutral footprint. Wind and solar are the most common renewable energy generation technologies that are utilized but any renewable or conventional energy production method can be incorporated and utilized in the campus.

Solar Panel Farm

The exemplary campus 500 can include solar 553 renewable electrical power generation as part of the clean and self-sustainable design. Solar panels 553 would be installed to feed produced green energy into the battery storage and microgrid system 561.

Wind Mill Farm

The exemplary campus 500 design may include, where appropriate, wind power 552 as a renewable electrical power generation source.

Other Energy Sources

The exemplary clean energy campus 500 can be installed anywhere around the globe and will utilize by design the available energy production of the region. The campus 500 will, where appropriate, include other power methods as a renewable electrical power generation source. These may include fuel cells, dynamic or stored hydro generation, geothermal, tidal generation, or any other available energy source.

Battery Storage & Microgrid Controller

The clean energy campus 500 includes an electrical power control and energy storage system 561. The energy storage system 561 takes in all produced power to store and “wash” it to ensure a steady distribution that meets the variable demands of the refining process. Excess stored power can be either sold during peak demand periods to local businesses or to the local utilities and power companies. A primary goal is to produce and store the necessary electricity to reliably power the clean refining equipment and process. A secondary goal is to sell excess “green” power to outside customers. The receipt, delivery, and control of the electrical power is facilitated with a campus microgrid and microgrid equipment.

Power Storage

A power storage component 561 stores the power generated within the campus 500. Preferably, the power storage component 561 is modular and scalable. The source of the power storage may be a battery, super capacitor, etc. One non-limiting example of a modular and scalable power storage system is described in detail in U.S. patent application Ser. No. 17/499,811, filed Oct. 12, 2021, and incorporated by reference herein, in its entirety, into this disclosure. The present system 500 is not limited to the battery and microgrid system described therein, and can use any system that is designed to store power, as would be appreciated by one having ordinary skill in the art after consideration of the present application.

The power storage system 561 system is sized to handle the complete electrical production from the micro turbine 551 and renewable sources 552, 553 and the specific peak electrical demands for continuous operation of the clean refiner facilities 400.

As described above, the power storage component can include battery, capacitor, inverter, etc. One non-limiting example is the battery storage. An exemplary battery storage system 561 is shown in FIG. 6 as a high efficiency lithium-ion battery pack, but any power/energy storage device could be used. These battery packs are fitted in a cellular housing and are then installed in a hot swappable battery bank enclosure. Multiple enclosures are built into a custom stackable skid enclosure. This system is completely modular and scalable allowing for designs and sizing to meet exact fit for purpose demands. Exemplary features of the power storage system can include, but are not limited to: 2 mWh Mega-Grid ESS (Energy Storage System); Dimensions of 24×11×10 feet; and 2 mWh per modular refinery.

As shown in FIG. 6, the single pod 600 may be scaled with hundreds or even thousands of other pods 600 to create a grid. One thousand (1000) pods 600 may be grouped together to create a 1 MW grid 603A. Two thousand (2000) pods 600 may be grouped together to create a 2 MW grid 603B. Five thousand five hundred (5500) may be grouped together to create a 5.5 MW grid 603C. The exemplary individual grids 603A, 603B, and 603C are efficiently packed together to minimize the footprint in a given location. The individual grids 603A, 603B, 603C are stackable, expandable, and customizable. Any number of pods may be used to create a desired MW outcome 603D.

Power Collection Micro Grid

The power generation and power storage system 561 includes a microgrid collection system and control skid. The campus 500 has an internal electrical power collection microgrid that routes all produced power to the microgrid controller modules. This power collection system takes in all variable electrical production and rectifies and transforms that energy into a common storable voltage and form. It also takes the stored power electricity and converts it to a standard distribution voltage and form that is sent to substation for the utilization in the clean refinery 400 or for utility electrical sales. An exemplary specification for the power collection micro grid includes: 600 kWh Hybrid Inverter/Microgrid Controller/Transformer; Dimensions: ˜16×11×10 feet; can be stacked on top of the Mega-Grid Structure; and one Control structure per modular refinery.

Distribution Micro Grid & Substation

The clean energy campus 500 has an internal power distribution system that will receive power from multiple sources and distribute utility grade power to the clean refineries and other utility customers. The microgrid distribution system includes a small substation (for example, 361 in FIG. 3). This substation 361 connects to the third-party utility power lines for green energy sales as well as for an emergency electrical power source. A primary feed into this substation 361 is the power storage system 351. All of the campus 300 is fed by this internal substation 361 and micro grid 351.

Micro Grid

A microgrid is a distribution network that incorporates a variety of Distributed Energy Resources (DER) that can be optimized and aggregated into a single system. The integrated system can balance loads and generation with or without energy storage and is capable of islanding whether connected or not connected to a traditional utility power grid. Distributed energy resources typically include microturbines, solar photovoltaic (PV), wind turbines, fuel cells and battery storage. Microgrids can be connected to larger electricity grids, and in the event of a widespread outage, can disconnect from the main grid to operate independently and supply electricity to homes and businesses that are connected to the microgrid's electricity network.

Sub Station

The small internal campus substation 361 distributes all power to the clean energy campus 300. It is also a sales point for “green” energy to a public utility. It receives power from either a third-party utility 363 or microgrid controller modules 351.

Instrumentation & Control

Another component of the clean energy campus 300 is the automation and control system. Every component of the campus is controlled and optimized with a common control system and program. This overarching system is monitored and operated locally and will also be monitored and optimized remotely at a central control center 331 or at remote terminals. Additional artificial intelligence (AI) analytic enterprise software may be incorporated that can remotely monitor the refinery equipment and the power process. This software has imbedded predictive algorithms for maintenance and production optimization. The goals of using this type of system are primarily safe operations and then efficient operations and optimization of the campus. Each site's automation is customizable to control the specific equipment and requirements of that particular campus.

Refinery Automation & Control

The Programmable Automation Controller (PAC) System is a high-performance automation controller and I/O subsystem integrated with easy-to-use WINDOWS based software. PAC hardware marries high performance, reliability and high I/O density with cost-effective redundancy options. The process modules and I/O system form the basis of a complete distributed control and recording environment capable of continuous analog, logic and sequential control combined with secure data recording at point of measurement; all designed to maximize system integrity. The PAC System is engineered with some of the most advanced, yet proven technologies available, and is very powerful, yet so simple to use. Among its many capabilities, it offers stunning visualization and seamless integration between the hardware and software, alongside the Visual intelligent local display and control. In a nutshell, the PAC System fully encapsulates the vast control, recording expertise and reputation that clients can depend on from Refinery Equipment of Texas, Inc. In addition, the PAC System is an integral component of the Expandable and Flexible Control System. This allows for new possibilities of open integration and efficiency that spans production operations and business.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A power system, comprising:
a refinery adapted to have an intake of crude oil and produce an output of refined products and vapors;
a micro turbine that produces power from the vapors from the refinery;
one or more sources of renewable energy which produce green power; and
a power storage center which stores total power formed by the power from the micro turbine and the green power.

2. The power system in claim 1, further comprising a grid which distributes the total power stored in the power storage center.

3. The power system in claim 1, wherein the green energy source is solar.

4. The power system in claim 1, wherein the green energy source is wind.

5. The power system in claim 1, wherein the green energy source is geothermal.

6. The power system in claim 1, wherein the green energy source is tidal.

7. The power system in claim 1, wherein the micro turbine is on a skid.

8. The power system in claim 1, wherein the vapor recovery system is on a skid.

9. The power system in claim 1, wherein the power storage center is on a skid.

10. The power system in claim 1, wherein the power storage center includes a modular battery.

11. A power system, comprising:
a refinery adapted to have an intake of crude oil and an output of refined products and fuel gas;
a vapor recovery unit which collects the fuel gas output from the refinery;
a micro turbine that produces power from the fuel gas collected by the vapor recovery unit;
one or more sources of green power;
a power storage center which stores total power formed by the micro turbine and the green power; and
a grid which distributes the total power stored in the power storage center.

12. The power system in claim 11, further comprising a renewable energy source which provides power to the power storage center.

13. The power system in claim 12, wherein the renewable energy source is solar.

14. The power system in claim 12, wherein the renewable energy source is wind.

15. The power system in claim 12, wherein the renewable energy source is geothermal.

16. The power system in claim 12, wherein the renewable energy source is tidal.

17. The power system in claim 11, wherein the micro turbine is on a skid.

18. The power system in claim 11, wherein the vapor recovery unit is on a skid.

19. The power system in claim 11, wherein the power storage center is on a skid.

20. A power system, comprising:
a refinery adapted to have an intake of crude oil and produce an output of refined products and vapors;
a modular vapor recovery unit positioned on a skid which collects the vapors produced in the refinery;
a modular micro turbine positioned on a skid that produces power from the vapors collected by the vapor recovery unit;
one or more sources of renewable energy which produce green power;
a modular power storage center positioned on a skid which stores a combination of power formed by the micro turbine and the green power; and
a modular grid positioned on a skid which distributes the combination power stored in the power storage center.
